(19) United States
(12) Patent Application Publication
(10) Pub. No.: US 2023/0122286 A1
(43) Pub. Date: Apr. 20, 2023

(54) METHOD FOR BUILDING A TEMPERATURE PREDICTION MODEL AND SETTING HEATING TEMPERATURE AND HEAT CYCLE SYSTEM

(71) Applicant: WISTRON CORP., New Taipei City (TW)

(72) Inventors: Yu Chien Lin, New Taipei City (TW); Cheng-Yang Chen, New Taipei City (TW); PEI-LING GU, New Taipei City (TW); Chia-Chiung Liu, New Taipei City (TW)

(21) Appl. No.: 17/685,455

(22) Filed: Mar. 3, 2022

(30) Foreign Application Priority Data
Oct. 20, 2021 (TW) 110138945

(51) Int. Cl. F22B 35/18; F22B 1/18; F22B 1/02; G05B 17/02

(52) U.S. Cl. CPC F22B 35/18; F22B 1/18; F22B 1/028; G05B 17/02

(57) ABSTRACT

A method for building a temperature prediction model is applicable to a heat cycle system, wherein the method is used to measure a temperature of the heat cycle system to generate a measured temperature data, and compute a response time of the heat cycle system, and the method includes aligning the measured temperature data and a setting value of the heat cycle system to generate a training data according to the response time; and building the temperature prediction model according to a statistic model and the training data.

### CROSS-REFERENCE TO RELATED APPLICATIONS

This non-provisional application claims priority under 35 U.S.C. § 119(a) on Patent Application No(s). 110138945 filed in Taiwan, ROC on Oct. 20, 2021, the entire contents of which are hereby incorporated by reference.

### BACKGROUND

### 1. Technical Field

This disclosure relates to a heat cycle system, more particularly to a method for building a temperature prediction model to predict a node temperature through data analysis, and a method for updating heater setting of the heat cycle system.

### 2. Related Art

With the rising prices of oil and electricity, energy saving and carbon reduction have become important issues. Effective energy saving not only reduces the cost of factory production, but also contributes to environmental protection.

Industrial boilers are common energy-consuming equipment in factories. The boilers and production machines in the factory form a heat cycle system, wherein the boiler uses fuels such as coal, diesel, or natural gas to heat the heat transfer oil. The high-temperature heat transfer oil after heating is sent to a heat accumulator through pipes, and then is delivered to machines such as hot press machine or impregnation machine for processing. These machines consume the thermal energy provided by the high-temperature heat transfer oil. The low-temperature heat transfer oil after temperature drop is returned to the heat accumulator, and then is sent to the boiler for reheating. However, the temperature of the returned heat transfer oil has drastically dropped, causing the temperature of the lower space of the heat accumulator to fluctuate sharply. When the low-temperature heat transfer oil is sent back to the boiler for reheating, more fuel needs to be burned to make the heat transfer oil return to high temperature required by the process, and thus wasting more energy.

### SUMMARY

According to one or more embodiment of the present disclosure, a method for building a temperature prediction model applicable to a heat cycle system, wherein the method is used to measure a temperature of the heat cycle system to generate a measured temperature data, and compute response time of the heat cycle system, and the method comprises: aligning the measured temperature data and a setting value of the heat cycle system to generate a training data according to the response time; and building the temperature prediction model according to a statistic model and the training data.

According to one or more embodiment of the present disclosure, wherein the heat cycle system comprises a heater, a heat-consuming machine, a delivery pipe, and a return pipe; the heater is configured to heat a thermal medium and transport the thermal medium with a raising temperature through the delivery pipe; the heat-consuming machine is configured to consume thermal energy of the thermal medium for processing and transport the thermal medium with a dropping temperature through the return pipe; and aligning the measured temperature data and the setting of the heat cycle system to generate the training data according to the response time comprises: determining a first operation node and a first response node of the heat cycle system, wherein the first operation node locates at a position where the heat-consuming machine outputs the thermal medium; obtaining an operating temperature data of the first operation node by a first temperature sensor, and obtaining a response temperature data of the first response node by a second temperature sensor, wherein the response temperature data comprises a plurality of response temperatures of the first response node at a plurality of time points; and performing following steps by a processor: obtaining a heater setting data of the heater, wherein the heater setting data comprises a plurality of heater settings of the heater at the plurality of time points; obtaining a machine setting data of the heat-consuming machine, wherein the machine setting data comprises a plurality of machine settings of the heat-consuming machine at the plurality of time points; measuring first response time between the first operation node and the first response node; and performing first data alignment according to the first response time to shift the plurality of response temperatures of the plurality of time points so as to align the plurality of response temperatures with the plurality of heater settings of the plurality of time points to generate the training data.

According to one or more embodiment of the present disclosure, wherein the first response time is an interval from the thermal medium performing a first heat operation at the first operation node to the thermal medium reacting to the first heat operation at first response node.

According to one or more embodiment of the present disclosure, wherein the heat cycle system further comprises a heat accumulator, the heater transports the thermal medium with the raising temperature to the heat accumulator through the delivery pipe, the heat accumulator provides the thermal medium to the heat-consuming machine through a supply pipe, the heat-consuming machine transports the thermal medium with the dropping temperature to the heat accumulator through the return pipe, and the method further comprises: determining a second operation node and a second response node of the heat cycle system, wherein the second operation node locates at a position where the heater outputs the thermal medium, and the second response node locates at a position where the heat accumulator receives the thermal medium; determining a third operation node and a third response node of the heat cycle system, wherein the third operation node locates at a position where the heat accumulator outputs the thermal medium, and the third response node locates at a position where the heat-consuming machine receives the thermal medium; measuring second response time between the second operation node and the second response node, wherein the second response time is an interval from the thermal medium performing a second heat operation at the second operation node to the thermal medium reacting to the second heat operation at second response node; measuring third response time between the third operation node and the third response node, wherein the third response time is an interval from the thermal medium performing a third heat operation at the third operation node to the thermal medium reacting to the third heat operation at third response node; and performing second data alignment by the processor, wherein the second data alignment shifts the plurality of machine settings of the plurality of time points to be aligned with the plurality of heating settings of the plurality of time points according to a sum of the second response time and the third response time; wherein the first data alignment further shifts the plurality of response temperatures of the plurality of time points to be aligned with the plurality of heater settings of the plurality of time points according to the sum of the second response time and the third response time, and the training data further comprises the machine setting data after being processed with the second data and the plurality of heater setting data.

According to one or more embodiment of the present disclosure, wherein measuring the first response time between the first operation node and the first response node comprises: generating a plurality of time-delayed temperature data according to a plurality of response temperature data, wherein the plurality of time-delayed temperature data corresponds to a plurality of time-delayed length respectively; computing a plurality of correlation coefficients, wherein each of the plurality of correlation coefficients is associated with an operating temperature data and one of the plurality of time-delayed temperature data; and setting the first response time, wherein the first response time is the time-delayed length corresponding to a maximum of the plurality of correlation coefficients.

According to one or more embodiment of the present disclosure, wherein the plurality of correlation coefficients is Pearson correlation coefficient.

According to one or more embodiment of the present disclosure, wherein the statistic model is linear regression model or Lasso regression model.

According to one or more embodiment of the present disclosure, wherein an estimation index of the statistic model is mean absolute error or mean absolute percentage error.

According to one or more embodiment of the present disclosure, wherein a temperature data of the heat cycle system is obtained by an operation interface, the heat cycle system comprises a response node, the temperature data comprises a temperature threshold corresponding to the response node, and the method comprises: generating a plurality of simulation temperatures according to a temperature prediction model; and obtaining the temperature threshold and determining each of the plurality of simulation temperatures according to the temperature threshold and the temperature data to update the heating temperature.

According to one or more embodiment of the present disclosure, wherein the temperature data further comprises a heat setting lower bound, a heat setting upper bound, and an adjustment interval, and the method further comprises performing following steps by a processor: obtaining a heater setting data and a machine setting data; and generating a plurality of simulation settings according to the heat setting lower bound and the adjustment interval, wherein each of the plurality of simulation settings is not greater than the heat setting upper bound.

According to one or more embodiment of the present disclosure, wherein generating the plurality of simulation temperatures according to the temperature prediction model comprises: inputting each of the plurality of simulation settings, the heater setting data, and the machine setting data to the temperature prediction model to generate the plurality of simulation temperatures.

According to one or more embodiment of the present disclosure, wherein determining each of the plurality of simulation temperature according to the temperature threshold and the temperature data to update the heating temperature comprises: determining whether each of the plurality of simulation temperatures is greater than the temperature threshold, wherein: when at least one of the plurality of simulation temperatures is not smaller than the temperature threshold, updating the heater setting data with the simulation setting corresponding to a minimum of said at least one of the plurality of simulation temperatures;

and when a maximum of the plurality of simulation temperatures is smaller than the temperature threshold, updating the heater setting data with the heat setting upper bound.

According to one or more embodiment of the present disclosure, wherein the heat cycle system comprises a heater, a heat-consuming machine, a delivery pipe, and a return pipe, the heater heats a thermal medium and transports the thermal medium with a raising temperature through the delivery pipe, and the heat-consuming machine consumes the thermal energy of the thermal medium for processing and transport the thermal medium with a dropping temperature through the return pipe.

According to one or more embodiment of the present disclosure, wherein obtaining the temperature data of the heat cycle system by the operation interface comprises: obtaining the response temperature data by a temperature sensor, wherein the response temperature data comprises a plurality of response temperatures of the response node at a plurality of time points.

According to one or more embodiment of the present disclosure, a heat cycle system comprising: a heater heating a thermal medium; a heat-consuming machine configured to receive the thermal medium from the heater; two temperature sensors disposed on an operation node and a response node respectively, wherein the operation node locates at a position where the heat-consuming machine outputs the thermal medium, and the response node locates at a position where the heater receives the thermal medium; and a processor communicably connecting to the two temperature sensors, wherein the processor builds a temperature prediction model configured to update a temperature setting of the heater.

According to one or more embodiment of the present disclosure, wherein the processor performs a set of instructions to build the temperature prediction model and the set of instructions comprises: obtaining a heater setting data of the heater, wherein the heater setting data comprises a plurality of heater settings of the heater at a plurality of time points; obtaining a machine setting data of the heat-consuming machine, wherein the machine setting data comprises a plurality of machine settings of the heat-consuming machine at the plurality of time points; computing a response time between the operation node and the response node; performing a data alignment to obtain a training data, wherein the data alignment shifts a plurality of response temperatures at the plurality of time points to be aligned with the plurality of heater settings at the plurality of time points at least according to the response time; and building the temperature prediction model according to a statistic model and the training data.

According to one or more embodiment of the present disclosure, further comprising: an input interface configured to obtain a temperature threshold of the response node, a setting lower bound, a setting upper bound, and an adjustment interval of the heater; wherein the processor is communicably connected to the input interface and the set of instructions further comprises: obtaining the heater setting data of the heater and the machine setting data of the heat-consuming machine; generating a plurality of simulation settings according to the setting lower bound and the adjustment interval, wherein each of the plurality of simulation settings is not greater than the setting upper bound; inputting each of the plurality of simulation settings, the heater setting data, and the machine setting data to the temperature prediction model to generate a plurality of simulation temperatures; determining whether each of the plurality of simulation temperatures is greater than the temperature threshold, wherein when at least one of the plurality of simulation temperatures is not smaller than the temperature threshold, updating the heater setting data with the simulation setting corresponding to a minimum of said at least one of the plurality of simulation temperatures; and when a maximum of the plurality of simulation temperatures is smaller than the temperature threshold, updating the heater setting data with the setting upper bound.

According to one or more embodiment of the present disclosure, further comprising: a heat accumulator comprising an upper space and a lower space connected to each other, wherein the upper space receives the thermal medium heated by the heater, and the lower space receives the thermal medium passing through the heat-consuming machine.

According to one or more embodiment of the present disclosure, wherein the statistic model is linear regression model or Lasso regression model.

According to one or more embodiment of the present disclosure, wherein an estimation index of the statistic model is mean absolute error or mean absolute percentage error.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of a heat cycle system according to an embodiment of the present disclosure;

FIG. 2 is a schematic diagram of the heat cycle system according to another embodiment of the present disclosure;

FIG. 3 is a flow chart of a method for building a temperature prediction model according to an embodiment of the present disclosure;

FIG. 4 is a detailed flow chart of step S2 in FIG. 3;

FIG. 5 is a broken line graph of the first operation node and the first response node in FIG. 2 based on the correlation coefficient and the time-delayed length;

FIG. 6 is a broken line graph of the second operation node and the second response node in FIG. 2 based on the correlation coefficient and the time-delayed length;

FIG. 7 is a broken line graph of the third operation node and the third response node in FIG. 2 based on the correlation coefficient and the time-delayed length;

FIG. 8A is a flow chart of a method for setting a heating temperature according to an embodiment of the present disclosure;

FIG. 8B is a flow chart of the method for setting a heating temperature according to another embodiment of the present disclosure;

FIG. 9 is a system block diagram of the heat cycle system according to an embodiment of the present disclosure; and

FIG. 10 is a schematic diagram of the heat cycle system according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

According to one or more embodiment of the present disclosure, further comprising: an input interface configured to obtain a temperature threshold of the response node, a setting lower bound, a setting upper bound, and an adjustment interval of the heater; wherein the processor is communicably connected to the input interface and the set of instructions further comprises: obtaining the heater setting data of the heater and the machine setting data of the heat-consuming machine; generating a plurality of simulation settings according to the setting lower bound and the adjustment interval, wherein each of the plurality of simulation settings is not greater than the setting upper bound; inputting each of the plurality of simulation settings, the heater setting data, and the machine setting data to the temperature prediction model to generate a plurality of simulation temperatures; determining whether each of the plurality of simulation temperatures is greater than the temperature threshold, wherein when at least one of the plurality of simulation temperatures is not smaller than the temperature threshold, updating the heater setting data with the simulation setting corresponding to a minimum of said at least one of the plurality of simulation temperatures; and when a maximum of the plurality of simulation temperatures is smaller than the temperature threshold, updating the heater setting data with the setting upper bound.

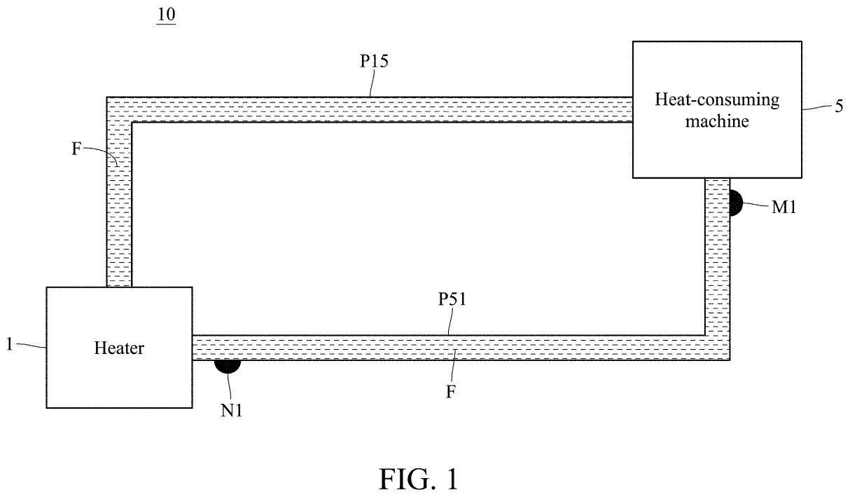

FIG. 1 is a schematic diagram of a heat cycle system 10 according to an embodiment of the present disclosure, such as a boiler system. The heat cycle system 10 shown in FIG. 1 includes a heater 1, a heat-consuming machine 5, a delivery pipe P15, a return pipe P51, and heat conductive medium F flowing in the delivery pipe P15 and return pipe P51. The delivery pipe P15 and return pipe P51 are configured to connect the heater 1 and the heat-consuming machine 5 and are served as transfer tubes between the two components. It should be noted that there is only one heat-consuming machine 5 in this embodiment, however, the present disclosure does not limit the number of heat-consuming machines 5.

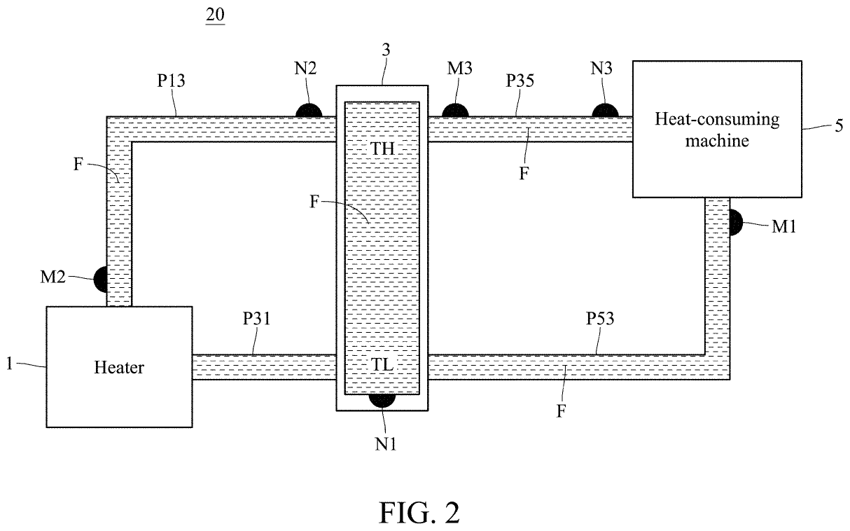

FIG. 2 is a schematic diagram of the heat cycle system 20 according to another embodiment of the present disclosure, such as a boiler system. The heat cycle system 20 shown in FIG. 2 includes a heater 1, a heat accumulator 3, a heat-consuming machine 5, a delivery pipe P13, a supply pipe P35, a return pipe P53, a return pipe P31, and heat conductive medium F flowing in the above pipes. The delivery pipe P13 is configured to connect the heater 1 and the heat accumulator 3, the supply pipe P35 is configured connect the heat accumulator 3 and the heat-consuming machine 5, the return pipe P53 is configured to connect the heat-consuming machine 5 and the heat accumulator 3, and the return pipe P31 is configured to connect the heat accumulator 3 and the heater 1. Similarly, this embodiment does not limit the number of the heat-consuming machines 5. Since the operating principles of the heat cycle systems 10, 20 are similar, with the main difference being whether the heat accumulator 3 is included, the following describes the heat cycle systems 10, 20 comprehensively.

Please refer to FIG. 2. For example, the heater 1 may be a boiler for burning coal, diesel, natural gas and/or other fuels to heat the heat transfer medium F. The present disclosure does not limit the number of boilers in the heater 1. The heat conductive medium F is configured to transfer and store the thermal energy. The heat conductive medium F is preferably the heat transfer oil when it is applied to a boiler system, however the present disclosure is not limited thereto. The heat conductive medium F may also be a gas or other heat conducting liquid when it is applied to other systems. For example, the heat-consuming machine 5 may be a hot press machine or an impregnation machine which consumes the thermal energy of the heat conductive medium F for processing. The heat accumulator 3 has an upper space TH and a lower space TL connecting to each other. The upper space TH receives the heat conductive medium F with a raising temperature through the delivery pipe P13, while the lower space TL receives the heat conductive medium F with a dropping temperature through the return pipe P53. The delivery pipe P13 is configured to transfer the heat conductive medium F with the raising temperature, and the return pipe P53 is configured to transfer the heat conductive medium F with the dropping temperature. The supply pipe P35 is configured to provide the heat conductive medium F stored in the upper space TH to the heat-consuming machine 5. It should be noted that in addition to the upper space TH and lower space TL, the heat accumulator 3 may include more spaces according to requirement in practice. For example, a middle space (not depicted) connected to one or more heat-consuming machines may be included in the heat accumulator 3.

The purpose of the present disclosure is to maintain the temperature of the heat conductive medium F of the designated node in the heat cycle systems 10, 20; that is, to improve the temperature stability of the heat conductive medium F. In the heat cycle system 10 shown in FIG. 1, the designated node may be located, for example, near the heater 1 in the return pipe P51. In the heat cycle system 20 shown in FIG. 2, the designated node may be, for example, at the location of the lower space TL in the heat accumulator 3.

The present disclosure arranges one or more temperature sensors, an input interface and a processor in the heat cycle systems 10, 20 shown in FIG. 1 and FIG. 2. The one or more temperature sensors are disposed on the designated node and configured to detect the temperature of the designated node. The input interface may generally refer to the command input window displayed on the monitor of the computer device and/or the physical command input tool, such as a keyboard, a mouse, etc. For example, the user may adopt the keyboard and the mouse to enter instructions or modify the parameter according to an embodiment of the present disclosure. In another example, the user may enter the instruction or modify the parameter through touch operation or voice control according to another embodiment of the present disclosure, which allows the physical instruction input tools to be omitted.

The processor (not depicted in FIG. 1) may be electrically connected to or communicably connected to the heater 1, the heat-consuming machine 5, the temperature sensor, and the input interface. Under the condition that the processor is communicably connected to the heater 1, heat-consuming machine 5, temperature sensor and the interface, the method for building a temperature prediction model and the method for setting a heating temperature proposed according to embodiments of the present disclosure can be performed and thus adding the functions of predicting the node's temperature and updating the heater settings of the heat cycle systems 10, 20.

In the heat cycle system 10 shown in FIG. 1, two temperature sensors are respectively disposed on the operation node M1 and the response node N1 of the return pipe P51. The operation node M1 locates at the position where the heat-consuming machine 5 outputs the heat conductive medium F. There is a designated distance between the response node N1 and the heat-consuming machine 5. The response node N1 may be disposed, for example, on the return pipe P51 and near the heater 1. These two temperature sensors obtain the operating temperature data of the operation node M1 and the response temperature data of the response node N1. The operating temperature data includes a plurality of operation temperatures of the operation node M1 at a plurality of time points. The response temperature data includes a plurality of response temperatures of the response node N1 at a plurality of time points. An interval of any two of the plurality of time points is the sensing period of the temperature sensor.

In the heat cycle system 20 shown in FIG. 2, the two temperature sensors (not depicted in FIG. 2) are respectively disposed on the operation node M1 and the response node N1 of the return pipe P53, another two temperature sensors are respectively disposed on the operation node M2 and the response node N2 of the delivery pipe P13, and further another two temperature sensors are respectively disposed on the operation node M3 and the response node N3 of the supply pipe P35. The operation node M2 locates at the position where the heater 1 outputs the heat conductive medium F. The response node N2 locates the position where the heat accumulator 3 receives the heat conductive medium F. The operation node M3 locates at the position where the heat accumulator 3 outputs the heat conductive medium F. The response node N3 locates at the position where the heat-consuming machine 5 receives the heat conductive medium F.

In order to ensure the temperature stability of the designated node, those factors affecting the temperature in the heat cycle systems 10, 20 have to be confirmed before the heat conductive medium F flows to the designated node. Taking FIG. 2 as an example, the present disclosure separates the heat cycle system 20 into three paths according to the heater 1, the heat accumulator 3 and the heat-consuming machine 5, each path is constructed by one of operation nodes M1, M2, M3 and corresponding one of the response nodes N1, N2, N3. For example, the path from heater 1 to the heat accumulator 3 composes of the operation node M2 and the response node N2, the path from the heat accumulator 3 to the heat-consuming machine 5 composes of the operation node M3 and the response node N3, and the path from the heat-consuming machine 5 to the heat accumulator 3 composes of the operation node M1 and the response node N1. In the three paths described above, current temperature measured by temperature sensors and current settings of the heater 1 and the heat-consuming machine 5 will affect the temperature of the lower space TL of the heat accumulator 3 after a while. The following explains how to calculate a time difference between heat operation at one of the operation nodes M1, M2, M3 and heat operation at corresponding one of the response nodes N1, N2, N3.

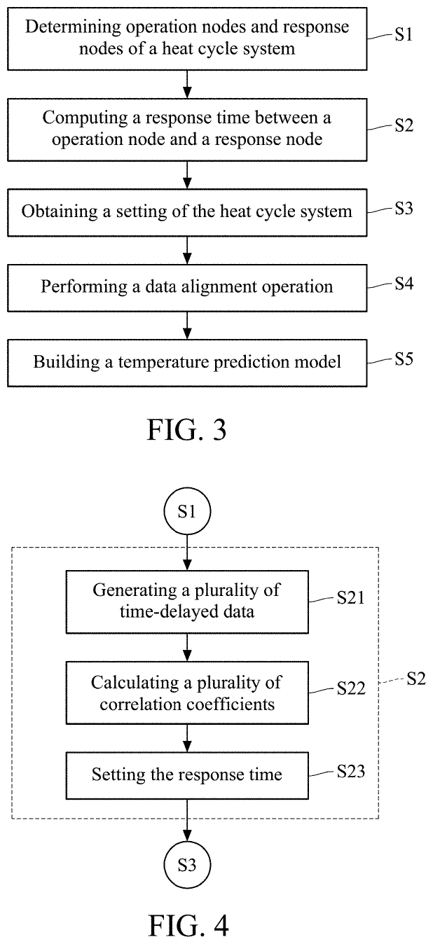

FIG. 3 is a flow chart of a method for building a temperature prediction model according to an embodiment of the present disclosure. The method is applicable to the heat cycle system 10, 20 shown in FIG. 1 and FIG. 2. The heat cycle system 20 of FIG. 2 is served as example and described below.

Step S1 represents “determining operation nodes and response nodes of a heat cycle system”. Specifically, in step S1, a plurality of temperature sensors is disposed on the operation nodes M1, M2, M3 and the response nodes N1, N2, N3 respectively, and the processor collects a plurality of temperature data measured by these temperature sensors.

Step S2 represents “computing a response time between an operation node and a response node”. The response time includes a first response time, a second response time and a third response time. The first response time may be viewed as the time interval that the heat conductive medium F at the operation node M1 starts to perform the first heat operation to the heat conductive medium F at the response node N1 reacts the first heat operation. The second response time may be viewed as the time interval that the heat conductive medium F at the operation node M2 starts to perform the second heat operation to the heat conductive medium F at the response node N2 reacts the second heat operation. The third response time may be viewed as the time interval that the heat conductive medium F at the operation node M3 starts to perform the third heat operation to the heat conductive medium F at the response node N3 reacts the third heat operation. In an embodiment, the first heat operation described above is that the heat-consuming machine 5 transfers the heat conductive medium F through the return pipe P53, the second heat operation is that the heater 1 transfers the heat conductive medium F through the delivery pipe P13, and the third heat operation is that the heat accumulator 3 transfers the heat conductive medium F through the supply pipe P35. Basically, the response time calculated by the processor in step S2 means that when temperature variation trends are measured at the operation nodes M1, M2, M3, after the response time elapsed, highly-similar temperature variation trends can be measured at the operation nodes N1, N2, N3 after the passing of the response time.

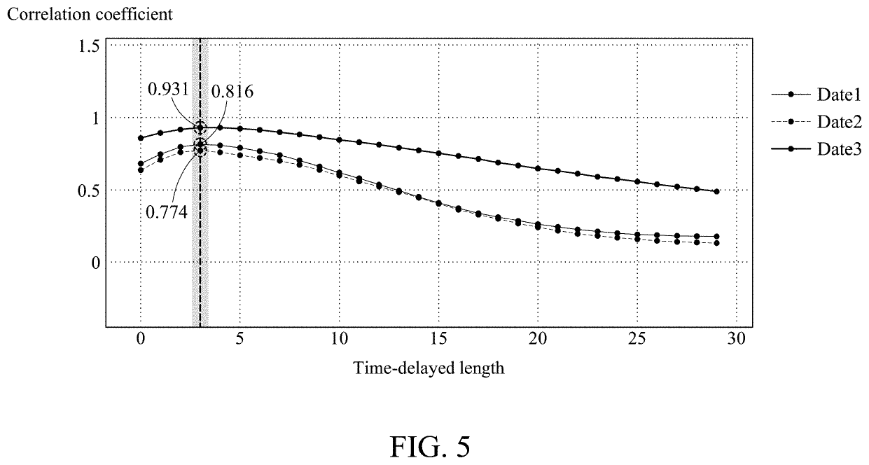

Please refer to FIG. 4. The following takes the operation node M1 and the response node N1 as example to explain how to calculate the first response time. As for the calculation methods of the second response time and the third response time may be deduced by the calculation method of the first response time.

Step S21 represents “generating a plurality of time-delayed data”. The processor generates a plurality of time-delayed temperature data according to the plurality of operating temperature data and the plurality of response temperature data, and these time-delayed temperature data correspond to a plurality of time-delayed length respectively. Specifically, the processor obtains a plurality of operation temperatures from the temperature sensor disposed on the operation node M1 at a plurality of time points, and obtains a plurality of response temperatures from the temperature sensor disposed on the response node N1 at the plurality of time points. These operation temperatures and response temperatures are shown in Table 1. According to the interval between two measurement times, the temperature sensor obtains a measured temperature value per 30 seconds, however, this interval can be adjusted according to the actual requirement.

TABLE 1

| | measurement time(hour/minute/seconds) | | | | | | | |
|---|---|---|---|---|---|---|---|---|
| | 12:34:00 | 12:34:30 | 12:35:00 | 12:35:30 | 12:36:00 | 12:36:30 | 12:37:00 | . . . |
| operation | 151 | 154 | 152 | 158 | 155 | 157 | 150 | . . . |
| temperature (° C.) | | | | | | | | |
| | measurement time (hour/minute/seconds) | | | | | | | |
| | 12:34:00 | 12:34:30 | 12:35:00 | 12:35:30 | 12:36:00 | 12:36:00 | 12:36:30 | . . . |
| response | 132 | 138 | 135 | 137 | 131 | 134 | 130 | . . . |
| temperature (° C.) | | | | | | | | |

In step S21, the processor generates a plurality of time-delayed temperature data according to the plurality of time-delayed lengths, these time-delayed lengths are multiples of a time-delayed unit. For example, if the time-delayed unit is 60 seconds, the plurality of time-delayed lengths may be 60 seconds, 120 seconds, 180 seconds, 240 seconds, etc., respectively. Taking an example that the time-delayed length is 60 seconds, the processor aligns “the response temperatures after the time-delayed length” with the current operating temperature to generate the time-delayed temperature data, as shown in Table 2. For example, the processor aligns the response temperature 135° C. measured at 12:35:00 with the operating temperature 151° C. at 12:34:00.

| | measurement time (hour/minute/seconds) | | | | | | | |
|---|---|---|---|---|---|---|---|---|
| | 12:34:00 | 12:34:30 | 12:35:00 | 12:35:30 | 12:36:00 | 12:36:30 | 12:37:00 | . . . |
| response | 151 | 154 | 152 | 158 | 155 | 157 | 150 | . . . |
| temperature (° C.) | | | | | | | | |
| | measurement time (hour/minute/seconds) | | | | | | | |
| | 12:35:00 | 12:35:30 | 12:36:00 | 12:36:30 | 12:37:00 | 12:37:30 | 12:38:00 | . . . |
| response | 135 | 137 | 131 | 134 | 130 | . . . | . . . | . . . |
| temperature (° C.) | | | | | | | | |

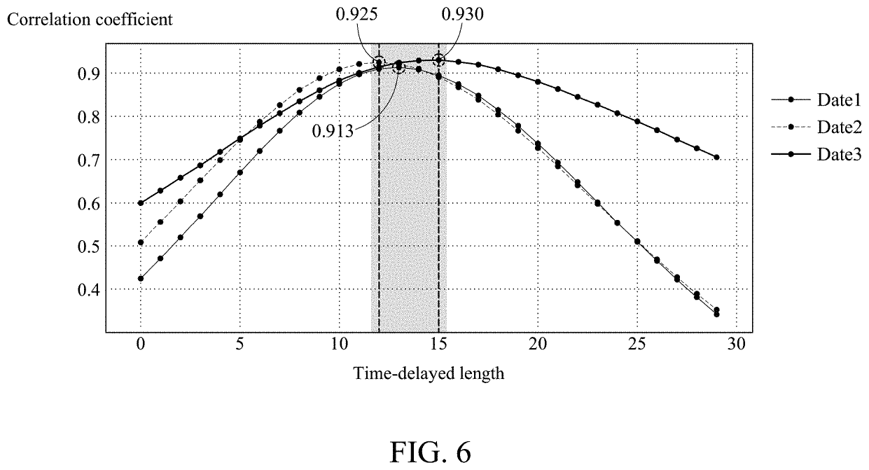

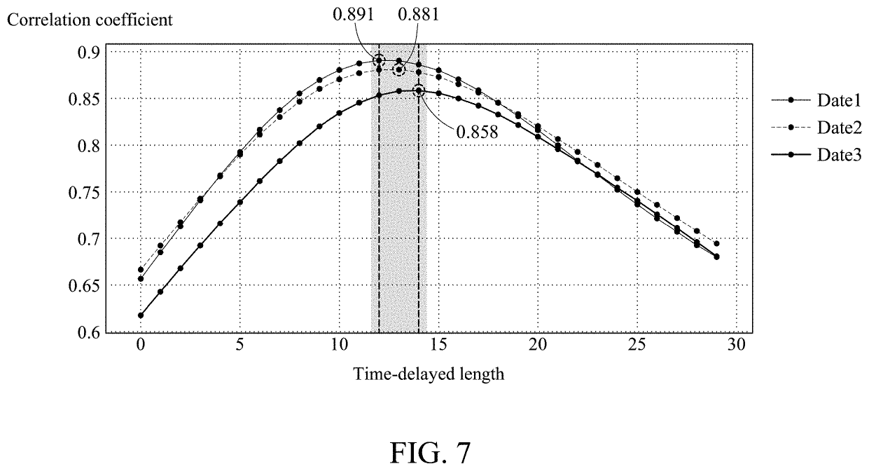

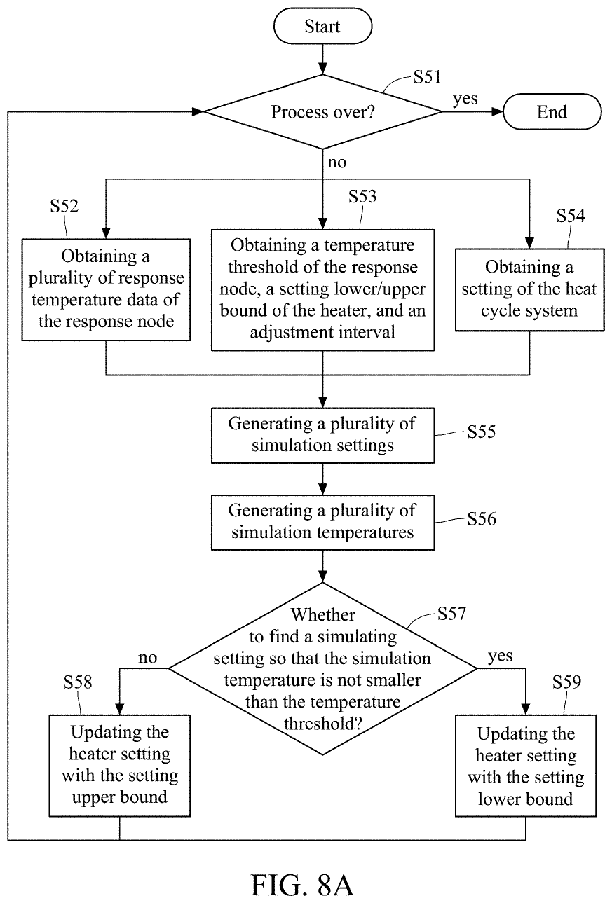

Step S22 represents “calculating a plurality of correlation coefficients” by the processor, wherein each correlation coefficient is associated with the operating temperature data and one of the plurality of time-delayed temperature data. For example, using the temperature values of two rows of Table 2 can calculate a correlation coefficient. In an embodiment of the present disclosure, the processor adopts Pearson correlation coefficient (Pearson product-moment correlation coefficient) for the calculation of the correlation coefficient. The processor may calculate the plurality of correlation coefficients according to the increment of the time-delayed lengths, and these correlation coefficients form a graph as shown in FIG. 5. FIG. 6 is a broken line graph using the operation node M2 and the response node N2 to calculate the correlation coefficient, while FIG. 7 is the broken line graph using the operation node M3 and the response node N3 to compute the correlation coefficient. In FIG. 5, FIG. 6, and FIG. 7, the processor calculates a plurality of correlation coefficients corresponding to different time-delayed lengths, and further calculates a plurality of correlation coefficients corresponding to different dates such as date 1, date 2, and date 3 shown in FIGS. 5-7.

Step S23 represents “setting the response time” by the processor, wherein the response time is the time-delayed length corresponding to the maximum of the plurality of correlation coefficients. Taking FIG. 5 as an example, the time-delayed length corresponding to the maximum 0.816 of the plurality of correlation coefficients of date 1 is “3”, the time-delayed length corresponding to the maximum 0.774 of the plurality of correlation coefficients of date 2 is “3”, and the time-delayed length corresponding to the maximum 0.931 of the plurality of correlation coefficients of date 3 is “3”. Therefore, the processor calculates an average of these three time-delayed lengths, i.e., (3+3+3)/3=3, as the first response time. Considering a previous-described example, when the time-delayed length is 3 and the time-delayed unit is 60 seconds, the first response time is 180 seconds.

Please refer to FIG. 3. Step S3 represents “obtaining setting data of the heat cycle system” by the processor. Specifically, the processor obtains the heater setting data of the heater 1 and the machine setting data of the heat-consuming machine 5. The heater setting data comprises a plurality of heater settings of the heater 1 at a plurality of time points, such as the temperature setting of the boiler, the valve opening or the flow of the input throttle of the boiler at the plurality of time points. The machine setting data comprises a plurality of machine settings of the heat-consuming machine 5 at a plurality of time points, such as the temperature setting, the pressure setting, the vacuum setting, etc. at the plurality of time points. It should be noted that the present disclosure does not limit the type and number of the setting data of the heat cycle system 20.

Step S4 represents “performing a data alignment operation” by the processor, wherein the data-alignment operation includes a first data-alignment operation and a second data-alignment operation. The first data-alignment operation shifts the plurality of response temperatures at the plurality of time points to be aligned with a plurality of heater settings at the plurality of time points at least according to first response time. In addition, the first data-alignment operation further shifts the plurality of response temperatures at the plurality of time points to be aligned with the plurality of heater settings at the plurality of time points according to the sum of the second response time and the third response time. The second data-alignment operation shifts the plurality of machine setting at the plurality of time points to be aligned with the plurality of heater settings at the plurality of time points according to the sum of the second response time and the third response time. For example, regarding the calculations of step S2, if the first response time is 3 minutes, the second response time is 11 minutes, and the third response time is 13 minutes, the processor can derive that the current heating settings and the machine settings after 24 minutes (11+13) will affect the temperature (i.e., the response temperature of the response node N1) of lower space TL of the heat accumulator 3 after 32 minutes (11+13+8). Therefore, the first alignment operation shifts the response temperatures after 32 minutes to be aligned with the current heater settings, and the second alignment operation shifts the machine settings after 24 minutes to be aligned with the current heater settings.

Step S5 represents “building a temperature prediction model” by the processor. Specifically, the processor builds the temperature prediction model according to statistic model and the training data. In an embodiment, the training data includes the machine setting data and the response temperature data after the first data-alignment operation is performed, and the heater setting data and the machine setting data after the second data-alignment operation is performed. Through the alignment process in step S4, the related variables affecting the temperature of the lower space TL of the heat accumulator 3 at the same time can be all listed as the training data. In an embodiment, the processor adopts Lasso regression to build the temperature prediction model. In another embodiment, the processor adopts linear regression to build the temperature prediction model. In addition, the evaluation index of the temperature prediction model may be, for example, Mean Absolute Error (MAE) or Mean Absolute Percentage Error (MAPE).

After building the temperature prediction model, the processor may input the heater setting data and the machine setting data to the temperature prediction model to generate a predicted temperature. This predicted temperature predicts the temperature of the response node N1 after the first response time passes. In addition, the present disclosure may use the predicted temperature generated by the temperature prediction model to fix the settings of the heater 1 instantly.

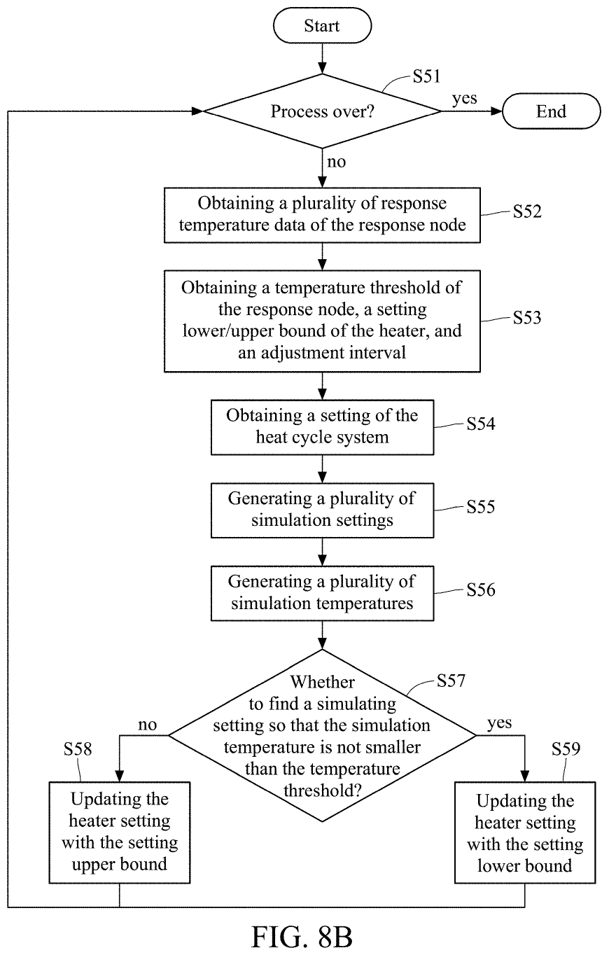

FIG. 8A is a flow chart of a method for setting a heating temperature according to an embodiment of the present disclosure, and this method is applicable to the heat cycle system 20 shown in FIG. 2. Step S51 shows that the processor determines whether the process is over. If the heat-consuming machine 5 has completed all process, the method for setting a heating temperature of the heat cycle system 20 will be terminated, otherwise steps S52-S54 will be performed. In FIG. 8A, steps S52-S54 are performed concurrently, however, the present disclosure is not limited thereto. Please refer to FIG. 8B, in another embodiment of the present disclosure, steps S52-S54 are performed sequentially.

Step S52 represents “obtaining a plurality of response temperature data of the response node”, wherein the processor obtains the response temperature data of the response node N1 of the heat cycle system 20 by the temperature sensor. The response temperature data includes the plurality of response temperatures of the response node N1 at the plurality of time points, i.e., the temperature of the lower space TL of the heat accumulator 3 at the plurality of time points.

Step S53 represents “obtaining a temperature threshold of the response node, a setting lower/upper bound of the heater, and an adjustment interval”. Specifically, the user inputs the above information by the input interface and the processor obtains the information by the input interface. The temperature threshold indicates that the user wants the response node N1 to be at least continuously maintained above the temperature threshold. The setting lower bound and the setting upper bound of the heater 1 reflect the heating capability of the heater 1. The adjustment interval is the minimum unit for each increase or decrease adjustment of the heating temperature of heater 1. For example, the temperature threshold is 215 degrees Celsius, the setting lower bound is 230 degrees, the setting upper bound is 240 degrees, and the adjustment interval is 0.5 degrees.

Step S54 represents “obtaining a setting data of the heat cycle system” by the processor. Specifically, the setting data includes the heater setting data of the heater 1 and the machine setting data of the heat-consuming machine 5.

Step S55 represents “generating a plurality of simulation settings” by the processor, i.e., the processor accumulates the adjustment interval according to the setting lower bound of the heater 1, until reaching the setting upper bound. In other words, under the premise that each simulation setting is not greater than the setting upper bound, the processor generates all temperatures that can be used by the heater 1. As the aforementioned example, a collection of these temperatures includes 230, 230.5, 231, 231.5, 232, 232.5, . . . , and 240, i.e., 31 simulation settings in total.

Step S56 represents “generating a plurality of simulation temperatures” by the processor. Specifically, the processor inputs the heater setting data and the machine setting data to the temperature prediction model according to each simulation setting to generate a plurality of simulation temperatures. As the aforementioned example, inputting 31 simulation settings may generate 31 simulation temperatures.

Step S57 represents that the processor determines that “whether to find a simulating setting so that the simulation temperature is not smaller than the temperature threshold”. In other words, the processor determines whether each simulation temperature is greater than the temperature threshold. Step S58, “updating the heater setting with the setting upper bound” will be performed by the processor if the maximal one of the simulation temperatures is smaller than the temperature threshold. In other words, even setting the heating setting value to the maximal value, the simulation temperature still does not reach above the temperature threshold, therefore, the maximal heating capability of the heater 1 has to be maintained so that the goal of the simulation temperature being above the temperature threshold may be achieved.

On the other hand, step S59, “updating the heater setting with the simulation setting” by the processor will be performed when at least one of the plurality of simulation temperatures generated in step S56 is not smaller than the temperature threshold. Specifically, the processor uses the simulation setting corresponding to the minimum of said at least one simulation temperatures to update the heater setting data. Since the plurality of simulation settings may satisfy the requirement that the simulation temperature is not smaller than the temperature threshold, only a minimum of these simulation settings needs to be the temperature setting for heating, and this can save heater's fuel consumption and achieve the goal of energy saving.

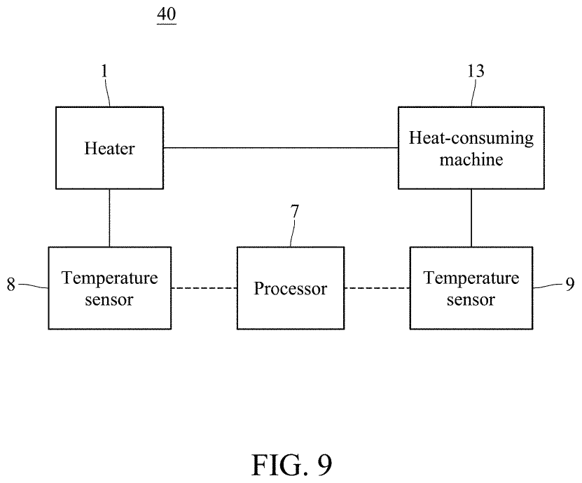

Please refer to FIG. 9. FIG. 9 is a system block diagram of the heat cycle system 40 according to an embodiment of the present disclosure. The heat cycle system 40 includes a heater 1 configured to heat a heat conductive medium, a heat-consuming machine 5 configured to receive the heat conductive medium from the heater 1; two temperature sensors 8, 9 disposed on the operation node and the response node respectively, wherein the operation node locates at the position where the heat-consuming machine 5 outputs the heat conductive medium, and the response node locates at the position where the heater 1 receives heat conductive medium; and a processor 7 communicably connected to the two temperature sensors 8, 9, wherein the processor builds the temperature prediction model configured to update the temperature setting of the heater 1.

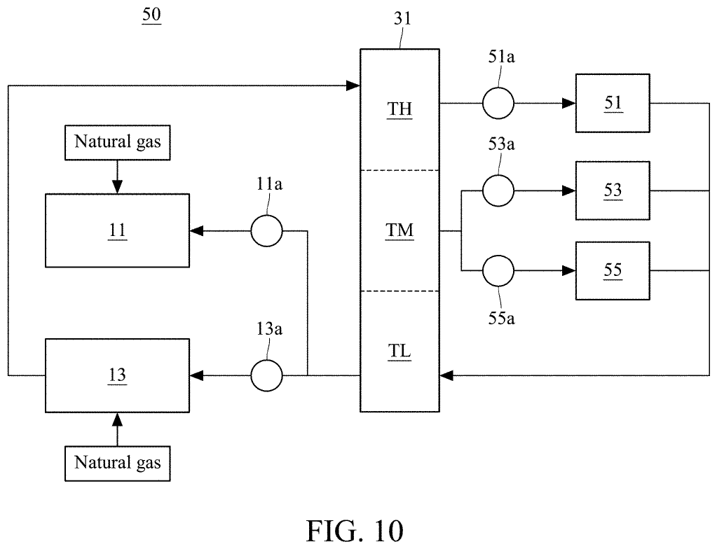

Please refer to FIG. 10. FIG. 10 is a schematic diagram of the heat cycle system 50 according to another embodiment of the present disclosure. The arrow direction in FIG. 10 represents the flow direction of the heat conductive medium F (e.g., heat transfer oil). In practice, the heater 1 includes two boilers 11, 13 connected to their respective boiler supply pump 11a, 13a. For example, the temperature setting of the boiler 11 can be adjusted, while the temperature setting of the boiler 13 is fixed (cannot be adjusted). However, the present disclosure is not limited thereto. Both boilers 11 and 13 use natural gas as heating material. The opening degree and the flow rate of the natural gas entering the boilers 11, 13 may be adjusted depending on practical requirement. The heated heat conductive medium F flows to the heat accumulator 31. The heat accumulator 31 includes the upper space TH, middle space TM, and lower space TL and these three spaces connect to each other. In the heat accumulator 31, the heat conductive medium F at the upper space TH has the highest temperature, the heat conductive medium F at the middle space TM has a second-highest temperature, and the heat conductive medium F at the lower space TL has the lowest temperature. The heat-consuming machine 5 includes a hot press machine 51, an impregnating hot air machine 53 and an impregnating hot plate welding machine 55. The heat conductive medium F in the upper space TL enters into the hot press machine 51 through the hot-pressing supply pump 51a, the heat conductive medium F in the middle space TM enters into the impregnating hot air machine 53 and the impregnating hot plate welding machine 55 respectively through the impregnating hot air supply pump 53a and the impregnating hot plate supply pump 55a. The heat-consuming machines 5 consume the thermal energy of the heat conductive medium F. The heat conductive medium F returns to the lower space TL of the heat accumulator 31, and is heated again by the boilers 11, 13. The above steps completes a heat cycle process. The heat cycle systems 10, 20 of previous embodiments may be easier to understand according to the heat cycle system 50 of this embodiment. However, this embodiment is not used to limit the scope of the present disclosure

In view of the above, the present disclosure disposes a plurality of operation nodes and a plurality of response nodes in the heat cycle system to form a plurality of paths in the heat cycle system. The present disclosure applies the cross-correlation technique to derive the response time reflecting the temperature variation of each node, and thus calculating an entire cycle time of the heat cycle system. The present disclosure further adopts feature engineering to select the setting data of the heat cycle system at different time points to perform the alignment operation. The present disclosure applies machine learning to build the temperature prediction model, further calculates the best temperature setting of the boiler, and thus achieving the target of energy saving and energy application efficiency improvement.

What is claimed is:

1. A method for building a temperature prediction model applicable to a heat cycle system, wherein the method is used to measure a temperature of the heat cycle system to generate a measured temperature data, and compute response time of the heat cycle system, and the method comprises:
aligning the measured temperature data and a setting value of the heat cycle system to generate a training data according to the response time; and
building the temperature prediction model according to a statistic model and the training data.

2. The method for building the temperature prediction model of claim 1, wherein the heat cycle system comprises a heater, a heat-consuming machine, a delivery pipe, and a return pipe; the heater is configured to heat a thermal medium and transport the thermal medium with a raising temperature through the delivery pipe; the heat-consuming machine is configured to consume thermal energy of the thermal medium for processing and transport the thermal medium with a dropping temperature through the return pipe; and aligning the measured temperature data and the setting of the heat cycle system to generate the training data according to the response time comprises:
determining a first operation node and a first response node of the heat cycle system, wherein the first operation node locates at a position where the heat-consuming machine outputs the thermal medium;
obtaining an operating temperature data of the first operation node by a first temperature sensor, and obtaining a response temperature data of the first response node by a second temperature sensor, wherein the response temperature data comprises a plurality of response temperatures of the first response node at a plurality of time points; and
performing following steps by a processor:
obtaining a heater setting data of the heater, wherein the heater setting data comprises a plurality of heater settings of the heater at the plurality of time points;
obtaining a machine setting data of the heat-consuming machine, wherein the machine setting data comprises a plurality of machine settings of the heat-consuming machine at the plurality of time points;
measuring first response time between the first operation node and the first response node; and
performing first data alignment according to the first response time to shift the plurality of response temperatures of the plurality of time points so as to align the plurality of response temperatures with the plurality of heater settings of the plurality of time points to generate the training data.

3. The method for building the temperature prediction model of claim 2, wherein the first response time is an interval from the thermal medium performing a first heat operation at the first operation node to the thermal medium reacting to the first heat operation at first response node.

4. The method for building the temperature prediction model of claim 2, wherein the heat cycle system further comprises a heat accumulator, the heater transports the thermal medium with the raising temperature to the heat accumulator through the delivery pipe, the heat accumulator provides the thermal medium to the heat-consuming machine through a supply pipe, the heat-consuming machine transports the thermal medium with the dropping temperature to the heat accumulator through the return pipe, and the method further comprises:
determining a second operation node and a second response node of the heat cycle system, wherein the second operation node locates at a position where the heater outputs the thermal medium, and the second response node locates at a position where the heat accumulator receives the thermal medium;
determining a third operation node and a third response node of the heat cycle system, wherein the third operation node locates at a position where the heat accumulator outputs the thermal medium, and the third response node locates at a position where the heat-consuming machine receives the thermal medium;
measuring second response time between the second operation node and the second response node, wherein the second response time is an interval from the thermal medium performing a second heat operation at the second operation node to the thermal medium reacting to the second heat operation at second response node;
measuring third response time between the third operation node and the third response node, wherein the third response time is an interval from the thermal medium performing a third heat operation at the third operation node to the thermal medium reacting to the third heat operation at third response node; and
performing second data alignment by the processor, wherein the second data alignment shifts the plurality of machine settings of the plurality of time points to be aligned with the plurality of heating settings of the plurality of time points according to a sum of the second response time and the third response time;
wherein the first data alignment further shifts the plurality of response temperatures of the plurality of time points to be aligned with the plurality of heater settings of the plurality of time points according to the sum of the second response time and the third response time, and the training data further comprises the machine setting data after being processed with the second data and the plurality of heater setting data.

5. The method for building the temperature prediction model of claim 2, wherein measuring the first response time between the first operation node and the first response node comprises:
generating a plurality of time-delayed temperature data according to a plurality of response temperature data, wherein the plurality of time-delayed temperature data corresponds to a plurality of time-delayed length respectively;
computing a plurality of correlation coefficients, wherein each of the plurality of correlation coefficients is associated with an operating temperature data and one of the plurality of time-delayed temperature data; and
setting the first response time, wherein the first response time is the time-delayed length corresponding to a maximum of the plurality of correlation coefficients.

6. The method for building the temperature prediction model of claim 5, wherein the plurality of correlation coefficients is Pearson correlation coefficient.

7. The method for building the temperature prediction model of claim 1, wherein the statistic model is linear regression model or Lasso regression model.

8. The method for building the temperature prediction model of claim 1, wherein an estimation index of the statistic model is mean absolute error or mean absolute percentage error.

9. A method for setting a heating temperature applicable to a heat cycle system, wherein a temperature data of the heat cycle system is obtained by an operation interface, the heat cycle system comprises a response node, the temperature data comprises a temperature threshold corresponding to the response node, and the method comprises:
generating a plurality of simulation temperatures according to a temperature prediction model; and
obtaining the temperature threshold and determining each of the plurality of simulation temperatures according to the temperature threshold and the temperature data to update the heating temperature.

10. The method for setting the heating temperature of claim 9, wherein the temperature data further comprises a heat setting lower bound, a heat setting upper bound, and an adjustment interval, and the method further comprises performing following steps by a processor:
obtaining a heater setting data and a machine setting data; and
generating a plurality of simulation settings according to the heat setting lower bound and the adjustment interval, wherein each of the plurality of simulation settings is not greater than the heat setting upper bound.

11. The method for setting the heating temperature of claim 10, wherein generating the plurality of simulation temperatures according to the temperature prediction model comprises:
inputting each of the plurality of simulation settings, the heater setting data, and the machine setting data to the temperature prediction model to generate the plurality of simulation temperatures.

12. The method for setting the heating temperature of claim 10, wherein determining each of the plurality of simulation temperature according to the temperature threshold and the temperature data to update the heating temperature comprises:
determining whether each of the plurality of simulation temperatures is greater than the temperature threshold, wherein:
when at least one of the plurality of simulation temperatures is not smaller than the temperature threshold, updating the heater setting data with the simulation setting corresponding to a minimum of said at least one of the plurality of simulation temperatures; and
when a maximum of the plurality of simulation temperatures is smaller than the temperature threshold, updating the heater setting data with the heat setting upper bound.

13. The method for setting the heating temperature of claim 9, wherein the heat cycle system comprises a heater, a heat-consuming machine, a delivery pipe, and a return pipe, the heater heats a thermal medium and transports the thermal medium with a raising temperature through the delivery pipe, and the heat-consuming machine consumes thermal energy of the thermal medium for processing and transport the thermal medium with a dropping temperature through the return pipe.

14. The method for setting the heating temperature of claim 9, wherein obtaining the temperature data of the heat cycle system by the operation interface comprises:
obtaining the response temperature data by a temperature sensor, wherein the response temperature data comprises a plurality of response temperatures of the response node at a plurality of time points.

15. A heat cycle system comprising:
a heater heating a thermal medium;
a heat-consuming machine configured to receive the thermal medium from the heater;
two temperature sensors disposed on an operation node and a response node respectively, wherein the operation node locates at a position where the heat-consuming machine outputs the thermal medium, and the response node locates at a position where the heater receives the thermal medium; and
a processor communicably connecting to the two temperature sensors, wherein the processor builds a temperature prediction model configured to update a temperature setting of the heater.

16. The heat cycle system of claim 15, wherein the processor performs a set of instructions to build the temperature prediction model and the set of instructions comprises:
obtaining a heater setting data of the heater, wherein the heater setting data comprises a plurality of heater settings of the heater at a plurality of time points;
obtaining a machine setting data of the heat-consuming machine, wherein the machine setting data comprises a plurality of machine settings of the heat-consuming machine at the plurality of time points;
computing a response time between the operation node and the response node;
performing a data alignment to obtain a training data, wherein the data alignment shifts a plurality of response temperatures at the plurality of time points to be aligned with the plurality of heater settings at the plurality of time points at least according to the response time; and
building the temperature prediction model according to a statistic model and the training data.

17. The heat cycle system of claim 16 further comprising:
an input interface configured to obtain a temperature threshold of the response node, a setting lower bound, a setting upper bound, and an adjustment interval of the heater; wherein
the processor is communicably connected to the input interface and the set of instructions further comprises:
obtaining the heater setting data of the heater and the machine setting data of the heat-consuming machine;
generating a plurality of simulation settings according to the setting lower bound and the adjustment interval, wherein each of the plurality of simulation settings is not greater than the setting upper bound;
inputting each of the plurality of simulation settings, the heater setting data, and the machine setting data to the temperature prediction model to generate a plurality of simulation temperatures;
determining whether each of the plurality of simulation temperatures is greater than the temperature threshold, wherein
when at least one of the plurality of simulation temperatures is not smaller than the temperature threshold, updating the heater setting data with the simulation setting corresponding to a minimum of said at least one of the plurality of simulation temperatures; and
when a maximum of the plurality of simulation temperatures is smaller than the temperature threshold, updating the heater setting data with the setting upper bound.

18. The heat cycle system of claim 15 further comprising:
a heat accumulator comprising an upper space and a lower space connected to each other, wherein the upper space receives the thermal medium heated by the heater, and the lower space receives the thermal medium passing through the heat-consuming machine.

19. The heat cycle system of claim 16, wherein the statistic model is linear regression model or Lasso regression model.

20. The heat cycle system of claim 16, wherein an estimation index of the statistic model is mean absolute error or mean absolute percentage error.
